(19) United States
(12) Patent Application Publication
(10) Pub. No.: US 2014/0078084 A1
(43) Pub. Date: Mar. 20, 2014

(54) ELECTRONIC DEVICE AND OPERATION DISPLAY METHOD OF OPERATION TERMINAL

(71) Applicant: BROTHER KOGYO KABUSHIKI KAISHA, Nagoya-shi (JP)

(72) Inventors: Junya KAWAI, Nagoya-shi (JP); Yuji IIDA, Nagoya-shi (JP)

(73) Assignee: BROTHER KOGYO KABUSHIKI KAISHA, Nagoya-shi (JP)

(21) Appl. No.: 14/022,517

(22) Filed: Sep. 10, 2013

(30) Foreign Application Priority Data
Sep. 19, 2012 (JP) 2012-206141

(51) Int. Cl. G06F 3/01

(52) U.S. Cl. CPC G06F 3/017
USPC 345/173

(57) ABSTRACT

An electronic device comprising at least one operation portion, a touch panel, a detecting portion, a memory, a trajectory determination processing portion, an operation control portion, a start point determining portion, a display control portion. The operation portion executes a predetermined processing operation. The detecting portion detects an operational input to the touch panel portion. The memory stores correlation between contact trajectories with predetermined patterns and the processing operations. The operation control portion, when it is determined that a contact trajectory with the predetermined pattern has been operationally input, refers to the correlation and control the operation portion so as to perform the processing operation. The display control portion, when it is determined that can become the start point has been made, refers to the correlation and control the display portion so as to perform guide display corresponding to the contact trajectory.

### CROSS-REFERENCE TO RELATED APPLICATION

The present application claims priority from Japanese Patent Application No. 2012-206141, which was filed on Sep. 19, 2012, the disclosure of which is incorporated herein by reference in its entirety.

### BACKGROUND

1. Field

The present disclosure relates to an electronic device provided with a touch panel portion and an operation display method of an operation terminal provided with a touch panel.

2. Description of the Related Art

A prior art in which an operator makes an operational input by contact (so-called gesture operation) to a touch panel portion provided on the electronic device so as to allow the electronic device to perform a desired operation has been already known. In this prior art, when an operator inputs any of a contact trajectory in a plurality of predetermined patterns set in advance to the touch panel portion, a processing operation (underline, shading, printing and the like) corresponding to the predetermined pattern is performed. At this time, even if the contact trajectory does not fully match the predetermined pattern, a similar predetermined pattern is selectably displayed at a stage when the operator has finished drawing a certain contact trajectory.

In the above described prior art, even if the operator does not accurately remember association between the predetermined pattern and the processing operation, a predetermined pattern similar to the contact trajectory the operator has finished drawing is selectably displayed, and thus, the operator can allow the electronic device to perform a desired operation intended by the operator.

However, the operator might not be able to recognize association between the pattern of the contact trajectory and the processing operation at all (does not remember the association or remembered it once but has forgotten it). In the above described prior art, the similar predetermined pattern is displayed as a selectable candidate at the stage when the operator has finished drawing some contact trajectory. Therefore, if the operator has completely forgotten above described association, the operator cannot cope with the problem and cannot allow the electronic device to perform desired processing, which is inconvenient.

### SUMMARY

The present disclosure has an object to provide an electronic device and an operation display method of an operation terminal which can perform a desired processing operation smoothly even if the operator cannot recognize association between the pattern of a contact trajectory and the processing operation and can improve convenience.

In order to achieve the above-mentioned object, according to the aspect, there is provided an electronic device comprising at least one operation portion which is configured to be capable of executing a predetermined processing operation and includes a display portion configured to perform a desired display, a touch panel portion provided above the display portion and capable of executing an operational input in a state where display on the display portion can be seen through, a detecting portion configured to detect the operational input by contact to the touch panel portion, a memory configured to store correlation between contact trajectories with a plurality of predetermined patterns in the touch panel portion and a plurality of the processing operations corresponding to the plurality of predetermined patterns, respectively, a trajectory determination processing portion configured to determine whether or not a contact trajectory with any of the predetermined patterns has been operationally input in the touch panel portion on the basis of a detection result of the detecting portion, an operation control portion configured, when it is determined by the trajectory determination processing portion that a contact trajectory with the predetermined pattern has been operationally input, to refer to the correlation stored in the memory and control the operation portion corresponding to the contact trajectory with the predetermined pattern so as to perform the processing operation corresponding to the predetermined pattern, a start point determining portion configured to determine whether or not contact that can become a start point of the contact trajectory with at least one of the predetermined pattern has been made in the touch panel portion, on the basis of the detection result of the detecting portion, and a display control portion configured, when it is determined by the start point determining portion that contact that can become the start point has been made, to refer to the correlation stored in the memory and control the display portion so as to perform guide display of at least one of the processing operations corresponding to the contact trajectory with at least one of the predetermined pattern including the start point, respectively.

### BRIEF DESCRIPTION OF THE DRAWING

FIG. 1 is a perspective view from a diagonally upper direction illustrating an appearance of a print label producing apparatus according to an embodiment of the present disclosure.

FIG. 2 is an enlarged plan view of the print label producing apparatus.

FIG. 3 is an explanatory diagram illustrating a display example of a label image displayed on a liquid crystal panel.

FIG. 4 is an enlarged plan view schematically illustrating an internal structure of a cartridge.

FIG. 5 is a conceptual diagram illustrating a control system of the print label producing apparatus.

FIG. 6 is an explanatory diagram of correlation illustrating correspondence between trajectory patterns of contact trajectories on a touch panel portion and corresponding processing operations.

FIG. 7A is an explanatory diagram illustrating execution of font type changing processing by an operational input through contact to the touch panel portion.

FIG. 7B is an explanatory diagram illustrating execution of font type changing processing by an operational input through contact to the touch panel portion.

FIG. 7C is an explanatory diagram illustrating execution of font type changing processing by an operational input through contact to the touch panel portion.

FIG. 8A is an explanatory diagram illustrating execution of character size changing processing by an operational input through contact to the touch panel portion.

FIG. 8B is an explanatory diagram illustrating execution of character size changing processing by an operational input through contact to the touch panel portion.

FIG. 8C is an explanatory diagram illustrating execution of character size changing processing by an operational input through contact to the touch panel portion.

FIG. 9A is an explanatory diagram illustrating execution of frame line adding processing by an operational input through contact to the touch panel portion.

FIG. 9B is an explanatory diagram illustrating execution of frame line adding processing by an operational input through contact to the touch panel portion.

FIG. 9C is an explanatory diagram illustrating execution of frame line adding processing by an operational input through contact to the touch panel portion.

FIG. 10A is an explanatory diagram illustrating execution of character italicizing processing by an operational input through contact to the touch panel portion.

FIG. 10B is an explanatory diagram illustrating execution of character italicizing processing by an operational input through contact to the touch panel portion.

FIG. 10C is an explanatory diagram illustrating execution of character italicizing processing by an operational input through contact to the touch panel portion.

FIG. 11A is an explanatory diagram illustrating guide display performed on the liquid crystal panel during contact with an upper right part on the touch panel portion.

FIG. 11B is an explanatory diagram illustrating guide display performed on the liquid crystal panel during contact with an upper right part on the touch panel portion.

FIG. 12A is an explanatory diagram illustrating guide display performed on the liquid crystal panel during contact with a lower right part on the touch panel portion.

FIG. 12B is an explanatory diagram illustrating guide display performed on the liquid crystal panel during contact with a lower right part on the touch panel portion.

FIG. 13 is a flowchart illustrating a processing procedure executed by a control circuit.

FIG. 14 is a flowchart illustrating a detailed procedure of Step S100 in FIG. 13.

FIG. 15A is an explanatory diagram illustrating a variation in which a mode of the guide display is changed by an arrival position of a fingertip.

FIG. 15B is an explanatory diagram illustrating a variation in which a mode of the guide display is changed by an arrival position of a fingertip.

FIG. 15C is an explanatory diagram illustrating a variation in which a mode of the guide display is changed by an arrival position of a fingertip.

FIG. 15D is an explanatory diagram illustrating a variation in which a mode of the guide display is changed by an arrival position of a fingertip.

FIG. 16 is a flowchart illustrating a processing procedure executed by the control circuit.

FIG. 17A is an explanatory diagram illustrating a variation in which cancellation is made possible by a deviating operation to the outside of a predetermined range.

FIG. 17B is an explanatory diagram illustrating a variation in which cancellation is made possible by a deviating operation to the outside of a predetermined range.

FIG. 17C is an explanatory diagram illustrating a variation in which cancellation is made possible by a deviating operation to the outside of a predetermined range.

FIG. 17D is an explanatory diagram illustrating a variation in which cancellation is made possible by a deviating operation to the outside of a predetermined range.

FIG. 18 is a flowchart illustrating a processing procedure executed by the control circuit.

FIG. 19A is an explanatory diagram illustrating a variation in which all the guide trajectories are displayed by a specific operation.

FIG. 19B is an explanatory diagram illustrating a variation in which all the guide trajectories are displayed by a specific operation.

### DETAILED DESCRIPTION OF THE PREFERRED EMBODIMENTS

An embodiment of the present disclosure will be described below by referring to the attached drawings. In the present embodiment, a case in which an electronic device of the present disclosure is applied to a print label producing apparatus will be indicated.

<Configuration of Print Label Producing Apparatus>

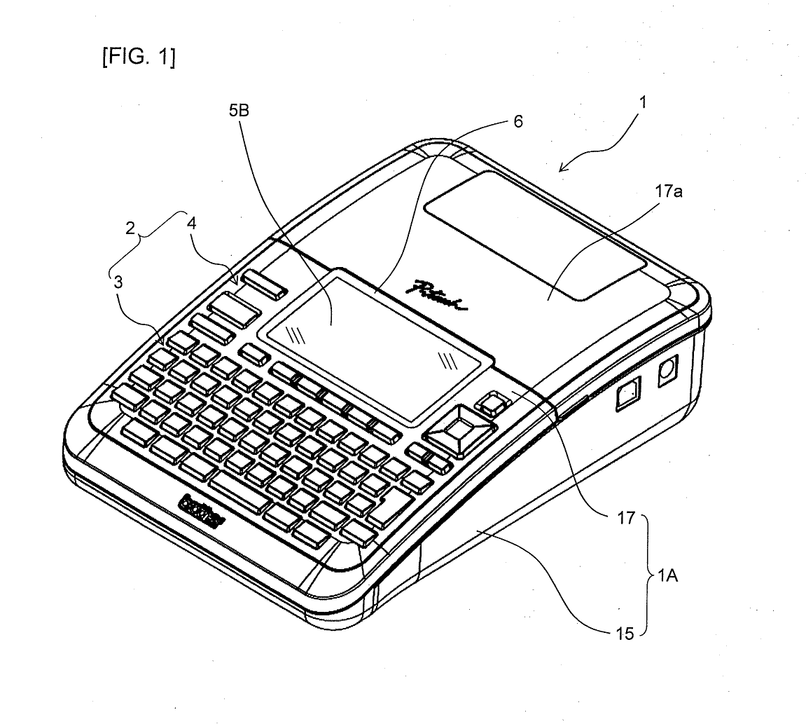

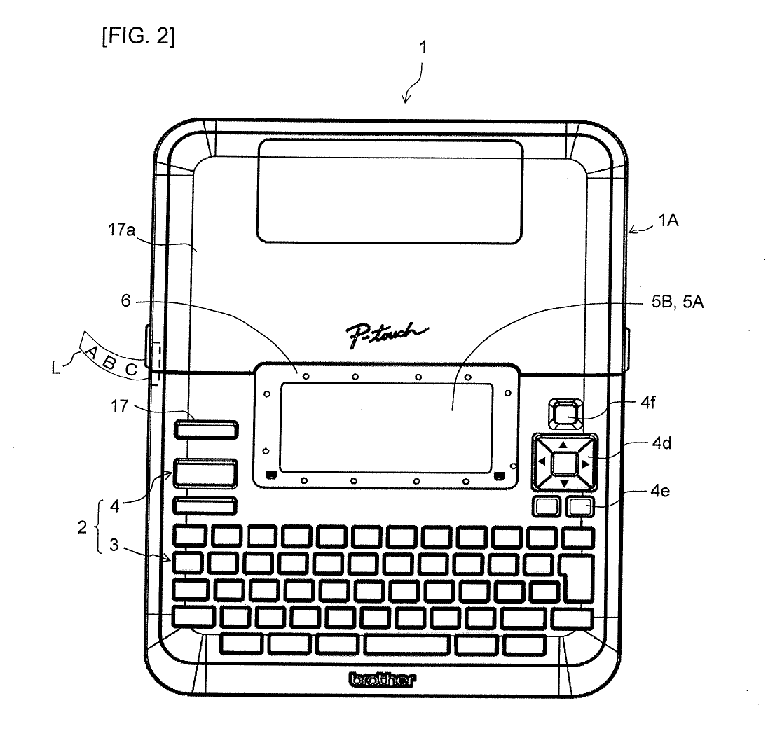

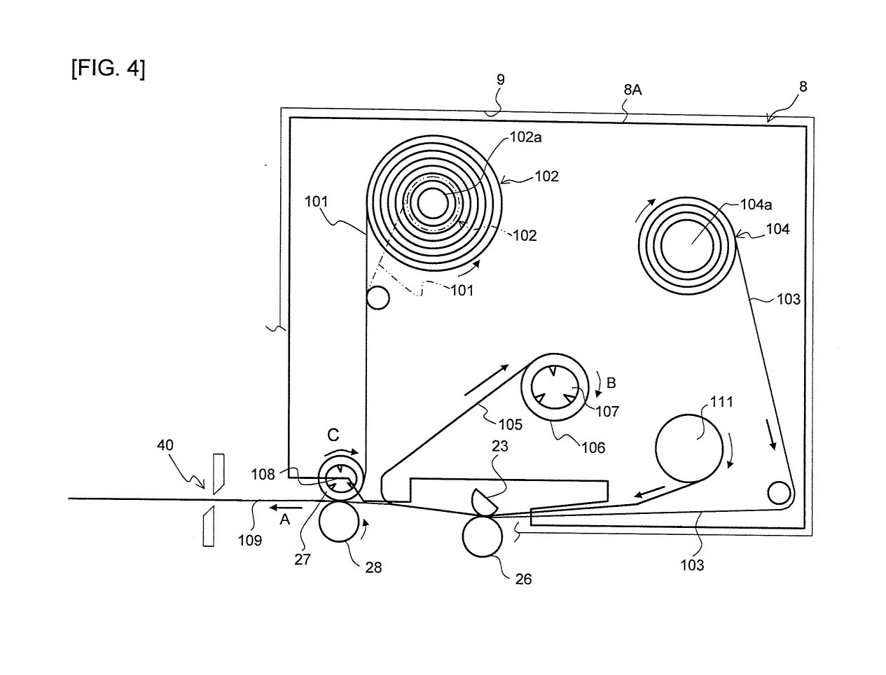

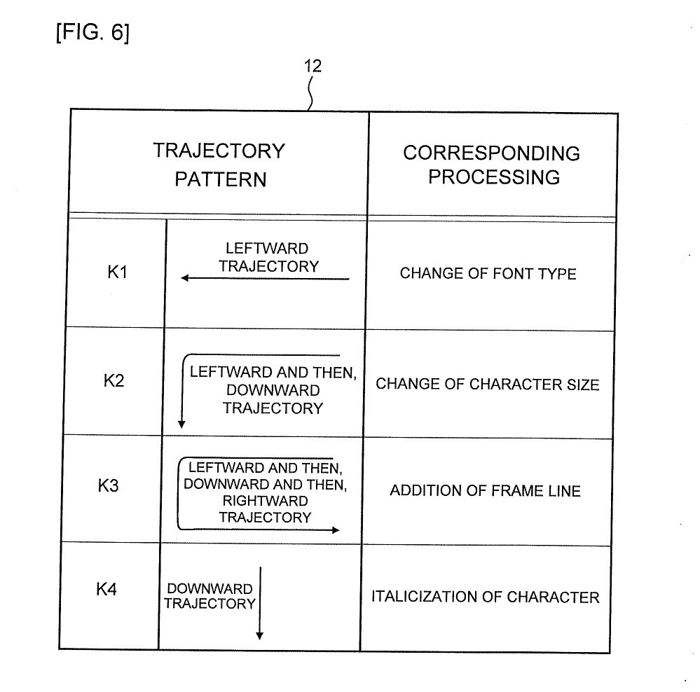

As illustrated in FIGS. 1 and 2, a print label producing apparatus 1 (corresponding to an electronic device) includes a housing 1A constituting an outer profile. The housing 1A is composed of a lower cover 15 made of resin and constituting a lower surface and a side surface of the apparatus and an upper cover 17 made of resin and constituting an upper surface of the apparatus. The upper cover 17 includes a cartridge cover 17a covering a cartridge holder 9 (See FIG. 4 which will be described later) on a rear part side, and the cartridge cover 17a can be opened/closed using a rear end portion as a fulcrum. On the front part side of the upper cover 17, an opening edge portion 6 in a rectangular shape, for example, is provided adjacent to the cartridge cover 17a. Inside the opening edge portion 6, a liquid crystal panel 5A (corresponding to a display portion. See FIG. 6 which will be described later, too.) is provided and immediately above that, a touch panel portion 5B through which an operator can make a desired operational input while visually checking display contents of the liquid crystal panel 5A in a transparent state is arranged. The operation portion 2 is provided in the periphery of the opening edge portion 6. On the operation portion 2, a keyboard 3 through which various operations such as character input are performed and a function key group for having various functions of the apparatus 1 executed such as a power switch, and up/down/right/left keys are arranged from the front to the rear of the upper cover 17. The function key group 4 includes a power button 4f at the right-side position of the opening portion 6, an up/down/right/left key 4d at the lower-side position thereof, and a print key 4e at the further lower-side position, for example.

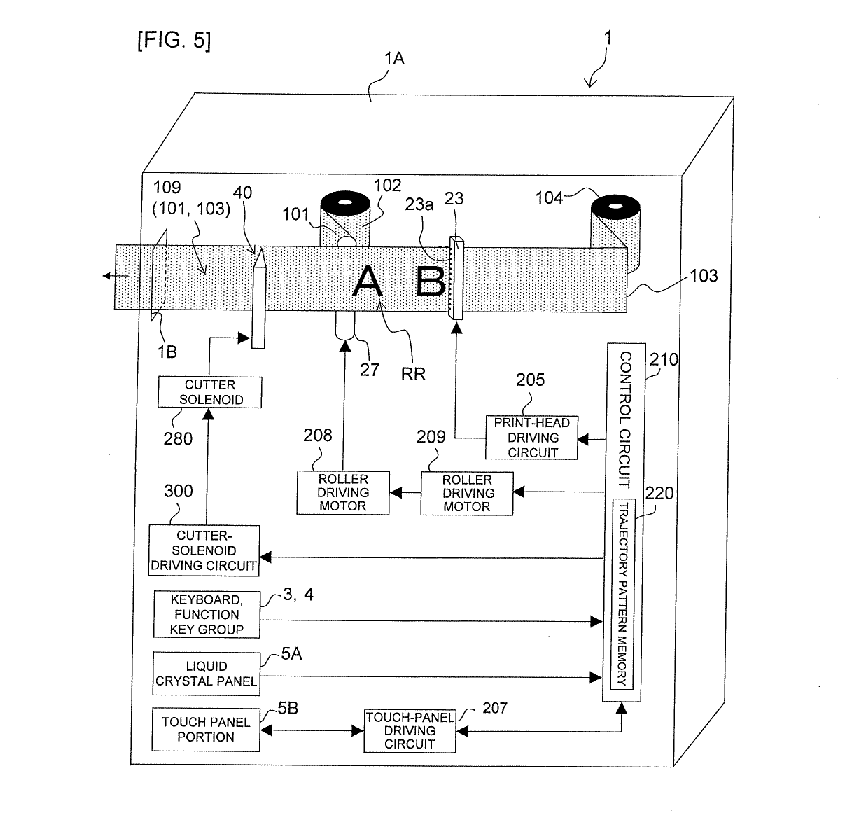

Inside the housing 1A, on the lower side of the touch panel portion 5B, for example, a main substrate, not shown, on which electronic elements (IC chip and the like) constituting a control circuit 210 (See FIG. 5 which will be described later) and the like which will be described later are mounted and a key substrate, not shown, connected to the control circuit 210 of the main substrate through a connector are provided. The key substrate has a plurality of key contacts corresponding to each key constituting the keyboard 3 and the function key group 4, and when the operator operates each key of the keyboard 3 and the function key group 4, the key contacts are closed, and whereby a function assigned to each key is executed.

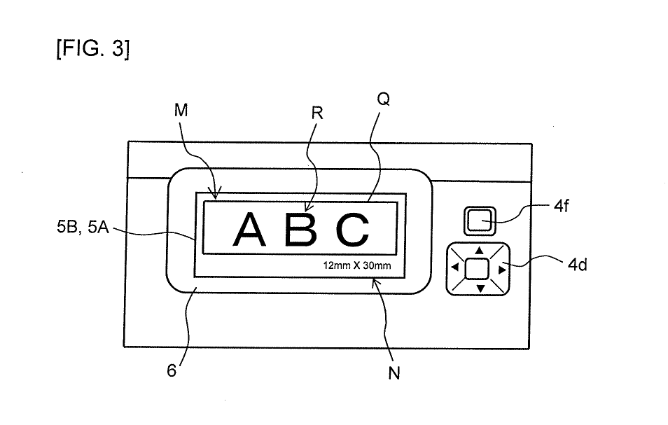

For example, the operator performs editing by inputting characters, symbols and the like while changing input positions displayed on the liquid crystal panel 5A and visually recognized through the touch panel portion 5B (hereinafter referred to simply as “displayed on the liquid crystal panel 5A” as appropriate) by using the keyboard 3, the up/down/right/left key 4d and the like. FIG. 3 illustrates an example of a state after the editing, in which a label image M (in this example, a print image R with the letters “ABC” and a rectangular label contour line image Q surrounding the print image R) is displayed on the liquid crystal panel 5A. The label image M edited as above is stored in a RAM, for example, provided in the control circuit 210. In FIG. 3, on the lower side of the label image M on the liquid crystal panel 5A, a dimension N (the width of 12 mm and the length of 30 mm in this example) of a print label L (See FIG. 2) to be produced by using the label image M is displayed.

<Cartridge Holder and Cartridge>

Inside the cartridge cover 17a of the housing 1A, as illustrated in FIG. 4, the cartridge holder 9 to which a cartridge 8 for supplying a label tape 109 with print can be detachably attached is provided. This cartridge holder 9 is normally closed by the cartridge cover 17a, and if the cartridge cover 17a is opened, the cartridge holder 9 is exposed. In the cartridge holder 9, a ribbon take-up roller driving shaft 107 for taking up a used ink ribbon 105 in the cartridge 8 and a feeding roller driving shaft 108 for feeding a cover film 103 (corresponding to a print-receiving medium) in the cartridge 8 are provided. Moreover, in the cartridge holder 9, a thermal head 23 (corresponding to printing head) for performing desired print on the cover film 103 is provided so as to be located at its opening portion when the cartridge 8 is attached. The thermal head 23 includes a plurality of heat generating elements 23a (See FIG. 5 which will be described later) arranged in a direction orthogonal to the feeding direction of the cover film 103, and print is performed on the cover film 103 by forming at least each dot on each print line formed by dividing the cover film 103 by print resolution in the feeding direction.

The cartridge 8 has a housing 8A, a first roll 102 (actually it has a spiral shape but illustrated as a concentric circular shape for facilitation in the figure) arranged in this housing 8A and around which a band-shaped base tape 101 is wound, a second roll 104 (actually it has a spiral shape but illustrated as a concentric circular shape for facilitation in the figure) around which the cover film 103 having substantially the same width as that of the base tape 101 but which is transparent is wound, a ribbon supply side roll 111 around which the ink ribbon 105 (heat transfer ribbon but not necessary if the print-receiving tape is a thermal tape) is wound, the ribbon take-up roller 106 taking up the ink ribbon 105 after print, and a feeding roller 27 rotatably supported in the vicinity of a tape discharge portion of the cartridge 8.

The first roll 102 has the base tape 101 wound around a reel member 102a. The base tape 101 is composed of a bonding adhesive layer, a base film, an affixing adhesive layer, and a separation sheet in this order from the inner wound side to the opposite side in lamination, for example. The second roll 104 has the cover film 103 wound around a reel member 104a.

The feeding roller 27 presses the base tape 101 and the cover film 103 on which print has been formed and bonds them while feeding so as to have the label tape 109 with print and feeds the obtained label tape 109 with print in a direction indicated by an arrow A in FIG. 4. The ribbon take-up roller 106 and the feeding roller 27 are rotationally driven in conjunction with each other as a driving force of a roller driving motor 208 (See FIG. 5 which will be described later) is transmitted to the ribbon take-up roller driving shaft 107 and the feeding roller driving shaft 108 (corresponding to feeder). During this rotational driving, a platen roller 26 arranged facing the thermal head 23 and a pressure roller 28 arranged facing the feeding roller 27 are similarly rotated (which will be described later).

Moreover, on the downstream side of the feeding roller 27 and the pressure roller 28 along a feeding path of the label tape 109 with print, a cutter 40 for cutting the label tape 109 with print to a predetermined length is provided. On the downstream side of the cutter 40, a label discharge port 1B (See FIG. 5 which will be described later) opened on the housing 1A is provided.

### <Control System of Print Label Producing Apparatus>

A control system of the apparatus 1 will be described by using FIG. 5. In FIG. 5, in the apparatus 1, a print-head driving circuit 205 for applying current to the heat generating elements 23a of the thermal head 23, a touch-panel driving circuit 207 for driving the touch panel portion 5B, a roller driving circuit 209 for controlling a roller driving motor 208 driving the feeding roller driving shaft 108 (See FIG. 4) and the ribbon take-up roller driving shaft 107 (See FIG. 4), a cutter-solenoid driving circuit 300 for controlling energization to a cutter solenoid 280 for causing the cutter 40 to perform a cutting operation, and the control circuit 210 for controlling operations of the entire print label producing apparatus 1 through the print-head driving circuit 205, the touch-panel driving circuit 207, the roller driving circuit 209, the cutter-solenoid driving circuit 300 and the like are provided. The keyboard 3 and the function key group 4 of the operation portion 2 are connected to the control circuit 210. The touch panel portion 5B is connected to the control circuit 210 through the above described touch-panel driving circuit 207. Then, an operation signal corresponding to each operation of the keyboard 3, the function key group 4, and the touch panel portion 5B is input to the control circuit 210. Moreover, the liquid crystal panel 5A is connected to the control circuit 210, and a label image such as a text and the like on the basis of the editing operation of the keyboard 3, the function key group 4 and the like and the operation of the touch panel portion 5B is displayed on the liquid crystal panel 5A. The control circuit 210 controls the print-head driving circuit 205, the roller driving circuit 209, the roller driving motor 208, the cutter-solenoid driving circuit 300 and the like in accordance with each setting by the operation of the operation portion 2 and the operation of the touch panel portion 5B.

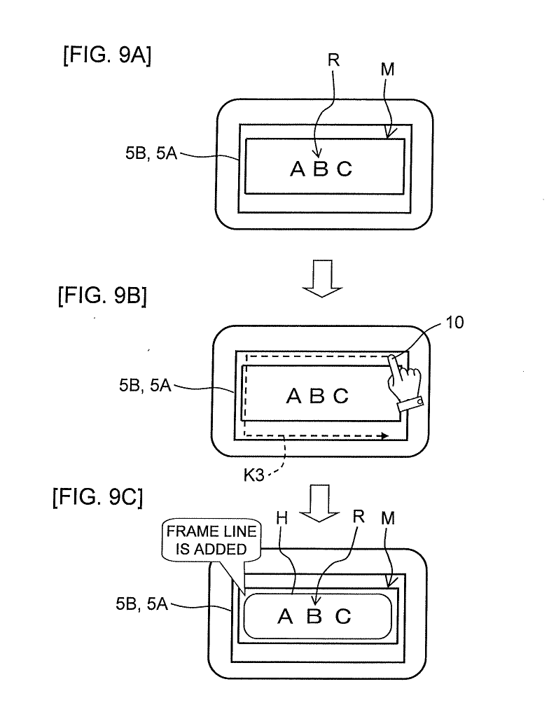

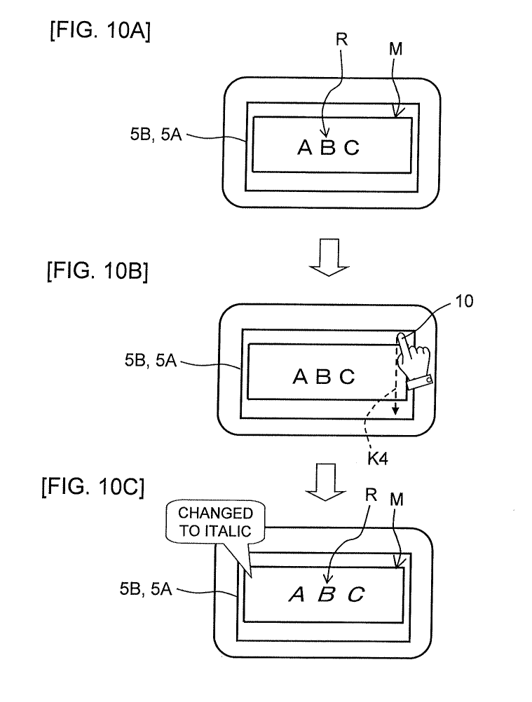

The control circuit 210 is a so-called microcomputer and is composed of, though detailed illustration is omitted, a CPU (calculating portion) which is a central processing unit, a ROM, a RAM and the like and includes a trajectory pattern memory 220 (corresponding to memory) composed of the EEPROM, for example. The control circuit 210 executes predetermined processing in accordance with a program stored in advance in the ROM (including a print label producing program for executing a print label producing method illustrated in FIGS. 9, 10 and the like which will be described later) while using a temporary storage function of the RAM.

The control circuit 210 is supplied with power from a power circuit and is connected to a communication line, for example, via a communication circuit so that information can be exchanged among a route server, other terminals, general-purpose computers, information servers and the like, not shown, connected to this communication line.

<Basic Operation of Print Label Producing Apparatus>

In the apparatus 1 with the above described configuration, when the cartridge 8 is attached to the cartridge holder 9, the cover film 103 and the ink ribbon 105 are sandwiched between the thermal head 23 and the platen roller 26, and the base tape 101 and the cover film 103 are sandwiched between the feeding roller 27 and the pressure roller 28. On the other hand, the label image produced through the editing operation through the keyboard 3 and the function key group 4 of the operation portion 2 is displayed on the liquid crystal panel 5A.

Then, along with driving of the feeding roller driving shaft 108, the ribbon take-up roller 106 and the feeding roller 27 are rotationally driven in directions indicated by an arrow B and an arrow C in FIG. 4, respectively, in synchronization. The pressure roller 28 is rotated by rotation of the feeding roller 27, the base tape 101 is fed out of the first roll 102 and supplied to the feeding roller 27, and the ink ribbon 105 is fed out of the ribbon supply roll 111 by rotation of the ribbon take-up roller 106. Moreover, the platen roller 26 is rotated by feeding-out of the ink ribbon 105, and the cover film 103 is fed out of the second roll 14 by rotation of the feeding roller 27, the pressure roller 28, and the platen roller 26 and supplied to the feeding roller 27. At this time, the plurality of heat generating elements 23a of the thermal head 23 is energized by the print-head driving circuit 205 on the basis of the label image displayed on the liquid crystal panel 5A. As a result, desired print RR (See FIG. 5) corresponding to the above described label image is printed on the back surface of the cover film 103 fed out of the second roll 104.

Then, the base tape 101 and the cover film 103 on which the above described printing has been finished are bonded and integrated by the feeding roller 27 and the pressure roller 28 to form the label tape 109 with print, which is fed out of the tape discharge portion to the outside of the cartridge 8. The ink ribbon 105 having finished with formation of the print RR on the cover film 103 is taken up by the ribbon take-up roller 106 by driving of the ribbon take-up roller driving shaft 107.

Subsequently, when the operator presses a cutter key provided in the function key group 4 of the operation portion 2, the cutter 40 on the downstream side in the label feeding direction of the feeding roller 27 is operated, the label tape 109 with print is cut to a predetermined length, and the print label L (See FIG. 2 which will be described later) having the predetermined length is produced. The produced print label L is fed by a discharge roller, not shown, on the downstream side in the label feeding direction of the cutter 40 to the discharge port 1B of the housing 1A and discharged from the discharge port 1B to the outside of the apparatus 1.

In the above, the liquid crystal panel 5A constitutes at least one operation portion for executing a production processing operation of the print label L together with the feeding roller driving shaft 108, the thermal head 23, the cutter 40 and the like.

<Feature 1 of the Present Embodiment>

One of features of the present embodiment is that an operator draws a contact trajectory with a predetermined pattern (hereinafter referred to simply as a “trajectory pattern” as appropriate) using the fingertip or the like on the label image M displayed on the liquid crystal panel 5A, and thereby an operation corresponding to the pattern is performed. An example of the trajectory pattern drawn on the touch panel portion 5B and processing executed in accordance with each pattern will be described below by referring to FIGS. 6 to 10.

<Correlation Between Trajectory Pattern and Operation>

Above-described association between the trajectory pattern drawn on the touch panel portion 5B and processing executed in accordance with each pattern is stored as correlation in the trajectory pattern memory 220 of the control circuit 210. An example of contents of this correlation is illustrated in FIG. 6.

The correlation illustrated in FIG. 6 shows individual correspondence relationships between a plurality of the trajectory patterns and a plurality of the processing operations in the touch panel portion 5B. In this example, the trajectory pattern (contact trajectory K1) drawn as a leftward straight line on the touch panel portion 5B is associated with changing processing of a font type on the characters of the print image R displayed on the liquid crystal panel 5A at that point of time. The trajectory pattern (contact trajectory K2) having the L-shape drawn as a leftward straight line and then, a downward straight line on the touch panel portion 5B is associated with changing processing of a character size on the characters of the print image R displayed on the liquid crystal panel 5A at that point of time. The trajectory pattern (contact trajectory K3) having the U-shape drawn as a leftward straight line, then, a downward straight line and then, a rightward straight line on the touch panel portion 5B is associated with processing of addition of a frame line on the characters of the print image R displayed on the liquid crystal panel 5A at that point of time. The trajectory pattern (contact trajectory K4) drawn as a downward straight line on the touch panel portion 5B is associated with italicization processing on characters of the print image R displayed on the liquid crystal panel 5A at that point of time.

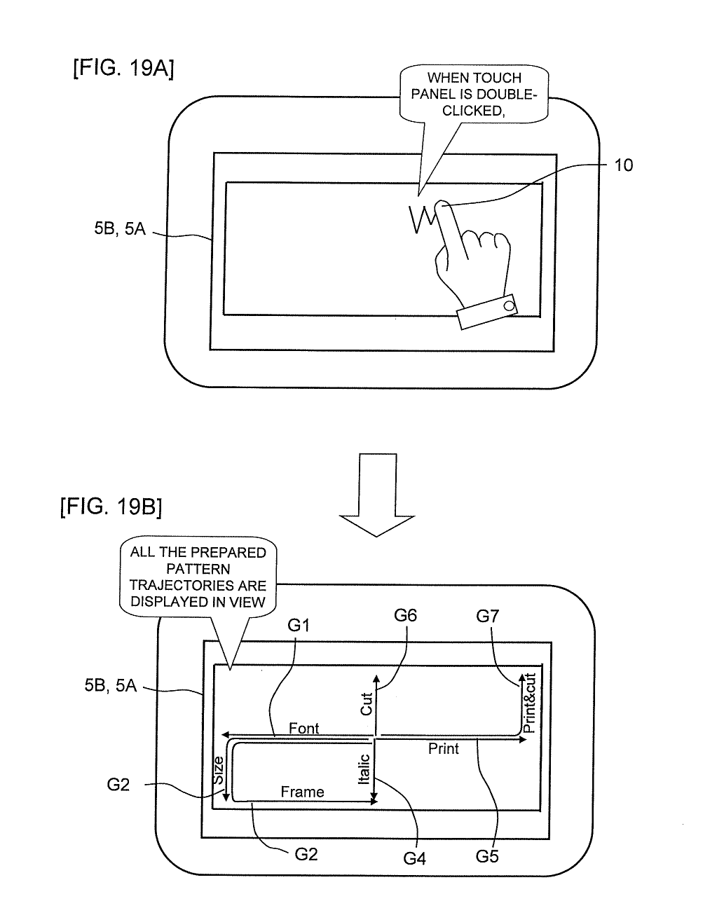

Other than the above described examples, predetermined trajectory patterns (See variation of FIG. 19 and the like which will be described later) for executing printing processing on the cover film 103 by means of collaboration of the feeding roller driving shaft 108 and the thermal head 23, cutting processing on the label tape 109 with print by the cutter 40 and the like may be incorporated in the above described correlation.

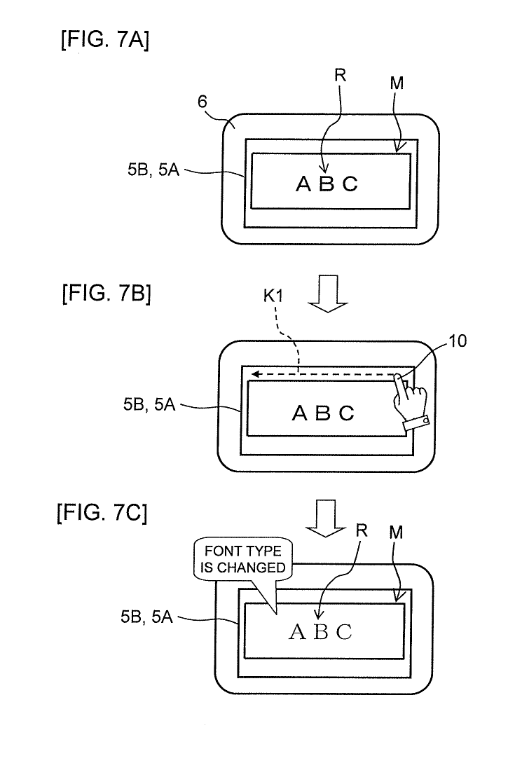

When the operator performs an operational input of the trajectory pattern by the finger 10 which touches the touch panel portion 5B and the like, the control circuit 210 refers to the correlation as illustrated in FIG. 6 on the basis of a detection result of the detected trajectory pattern and controls the operation portion corresponding to the processing operation (the liquid crystal panel 5A, the feeding roller driving shaft 108, the thermal head 23, the cutter 40 and the like) so that the processing operation according to the detected trajectory pattern is executed. Examples of such processing operations are illustrated below in FIGS. 7 to 10.

<Font Type Changing Processing>

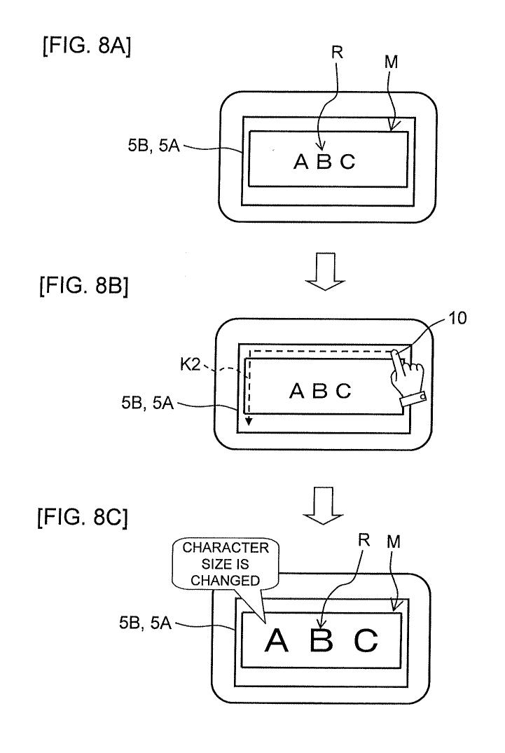

FIG. 7 is an explanatory diagram illustrating a case in which changing processing of a font type is executed. In FIG. 7A, the label image M being edited by the operator is displayed on the liquid crystal panel 5A. In this example, the print image R included in the label image M is Gothic characters “ABC”. In this state, as illustrated in FIG. 7B, if the operator touches one point (an upper right part in this example) on the touch panel portion 5B with the finger 10 and moves the touching finger 10 in the left direction on the touch panel portion 5B, for example, the contact trajectory K1 which is the leftward trajectory pattern is drawn. As a result, the changing processing of a font type associated with the leftward contact trajectory K1 on the basis of the correlation in FIG. 6 is executed. In this example, as illustrated in FIG. 7C, the font type of the characters “ABC” displayed on the liquid crystal panel 5A has been changed from the Gothic font to the Ming style font. In the above described example, the contact trajectory K1 is drawn in a region corresponding to the outer side of the label image M in the touch panel portion 5B, but this is not limiting, and the contact trajectory K1 may be drawn in a region corresponding to the inner side of the label image M (the same also applies to examples illustrated in FIGS. 8 to 10 and the like).

<Character Size Changing Processing>

FIG. 8 is an explanatory diagram illustrating a case in which changing processing of a character size is executed. In FIG. 8A, similarly to the above described FIG. 7A, the print image R is the characters “ABC” in the (Gothic) font with the character size 18, for example. In this state, as illustrated in FIG. 8B, if the operator touches one point (the upper right part in this example) on the touch panel portion 5B with the finger 10 and moves the touching finger 10 in the left direction on the touch panel portion 5B and then, moves it downward, the contact trajectory K2 which is the L-shaped trajectory pattern is drawn. As a result, the character size changing processing associated with the contact trajectory K2 on the basis of the correlation in FIG. 6 is executed. In this example, as illustrated in FIG. 8C, the character size of the characters “ABC” displayed on the liquid crystal panel 5A is increased from the character size 18 to the character size 28, for example.

<Frame-Line Addition Processing>

FIG. 9 is an explanatory diagram illustrating a case in which addition processing of a frame line is executed. In FIG. 9A, similarly to the above described FIG. 7A and FIG. 8A, the print image R includes the characters “ABC”. In this state, as illustrated in FIG. 9B, if the operator touches one point (the upper right part in this example) on the touch panel portion 5B with the finger 10 and moves the touching finger 10 in the left direction on the touch panel portion 5B and then, moves it downward, and then, further moves it in the right direction, the contact trajectory K3 which is the U-shaped trajectory pattern is drawn. As a result, the frame-line addition processing associated with the contact trajectory K3 on the basis of the correlation in FIG. 6 is executed. In this example, as illustrated in FIG. 9C, a frame line H surrounding the characters “ABC” of the print image R displayed on the liquid crystal panel 5A is added.

<Italicization Processing>

FIG. 10 is an explanatory diagram illustrating a case in which character italicization processing is executed. In FIG. 10A, similarly to the above described FIG. 7A, FIG. 8A, and FIG. 9A, the print image R includes the characters “ABC” (not in italic but in a normal style). In this state, as illustrated in FIG. 10B, if the operator touches one point (the upper right part in this example) on the touch panel portion 5B with the finger 10 and moves the touching finger 10 downward on the touch panel portion 5B, the contact trajectory K4 which is the downward straight line trajectory pattern is drawn. As a result, the italicization processing associated with the contact trajectory K4 on the basis of the correlation in FIG. 6 is executed. In this example, as illustrated in FIG. 10C, the style of the characters “ABC” displayed on the liquid crystal panel 5A is italicized.

<Feature 2 of the Present Embodiment>

As described above, the operator can make each operation portion perform a desired operation (various types of display processing on the liquid crystal panel 5A in the examples of the above described FIGS. 7 to 10) by drawing various types of the trajectory patterns on the touch panel portion 5B. However, the operator might not be able to recognize contents of the correlation (what processing operation is associated with what trajectory pattern). Specifically, there can be cases in which the operator does not remember the above described association, the operator remembered but forgets the association and the like.

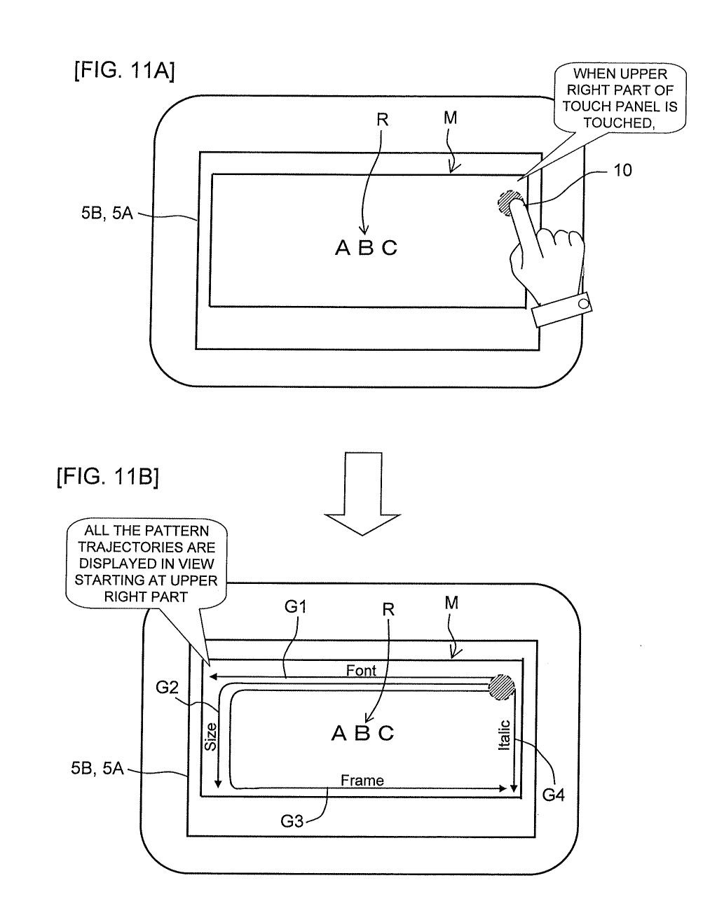

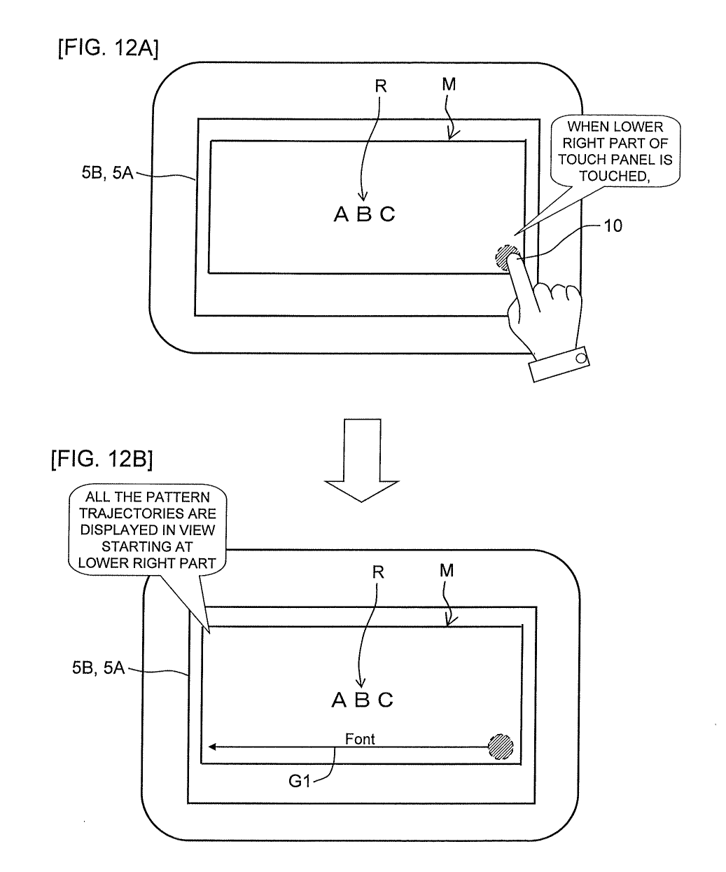

Thus, in the present embodiment, in accordance with the above described cases, if the operator touches an appropriate point on the touch panel portion 5B, guide display of all the trajectory patterns that can start at that point and a processing operation corresponding to the trajectory patterns is made on the liquid crystal panel 5A. Details of the example of the guide display will be described below by referring to FIGS. 11 and 12.

<Guide Display Example when Upper Right Part on Touch Panel Portion is Touched>

In the example illustrated in FIG. 11A, for example, the print image R included in the label image M includes characters “ABC” on the liquid crystal panel 5A. In this state, as illustrated in FIG. 11A, the operator touches the upper part on the right side of the touch panel portion 5B with the finger 10, for example (a contact point is conceptually indicated by a shaded circle in the figure). Then, as illustrated in FIG. 11B, the contact trajectories equivalent to all the trajectory patterns (corresponding to the guide trajectory display) starting at the upper right part and names of the processing operations corresponding to those contact trajectory patterns are displayed in a view as the guide display on the liquid crystal panel 5A. In this example, four types of the guide display, that is, display of a guide trajectory G1 (equivalent to the above described contact trajectory K1) with the leftward straight line pattern and the name “Font” indicating the font type changing processing corresponding to the guide trajectory G1, display of a guide trajectory G2 (equivalent to the above described contact trajectory K2) with the leftward and then, downward L-shaped pattern and the name “Size” indicating the character size changing processing corresponding to the guide trajectory G2, display of a guide trajectory G3 (equivalent to the above described contact trajectory K3) with the leftward and then, downward and then, rightward U-shaped pattern and the name “Frame” indicating the frame-line addition processing corresponding to the guide trajectory G3, and display of a guide trajectory G4 (equivalent to the above described contact trajectory K4) with the downward pattern and the name “Italic” indicating the character italicization processing corresponding to the guide trajectory G4 are made.

<Guide Display Example when Lower Right Part on Touch Panel Portion is Touched>

Moreover, in a state where the label image M including the print image R of the characters “ABC” similar to the above is displayed, the operator touches a lower part on the right side of the touch panel portion 5B with the finger 10 as illustrated in FIG. 12A (a contact point is conceptually indicated by a shaded circle in the figure.). Then, as illustrated in FIG. 12B, the contact trajectories equivalent to all the trajectory patterns (corresponding to the guide trajectory display) starting at the lower right part and names of the processing operations corresponding to those trajectory patterns are displayed as the guide display on the liquid crystal panel 5A. In this example, one type of the guide display, that is, the guide trajectory G1 (equivalent to the above described contact trajectory K1) with the leftward straight line pattern and the name “Font” indicating the font type changing processing corresponding to the guide trajectory G1 are displayed.

When the guide display as in the above described FIGS. 11 and 12 is made, the operator sees the name of the processing operation included in the guide display and draws the contact trajectory along any one of the guide trajectories G1-G4 corresponding to the processing operation desired by the operator, on the touch panel portion 5B. As a result, the above described desired processing operation (the font type changing processing, the character size changing processing, the frame-line addition processing, the character italicization processing or the like in the above described example) can be executed. The examples in FIGS. 11 and 12 illustrate the case where displays of the guide trajectories G1-G4 are made in the inner side region of the label image M on the liquid crystal panel 5A, but this is not limiting, and may be made in the outer side region of the label image M.

<Control Procedure when Label is Produced>

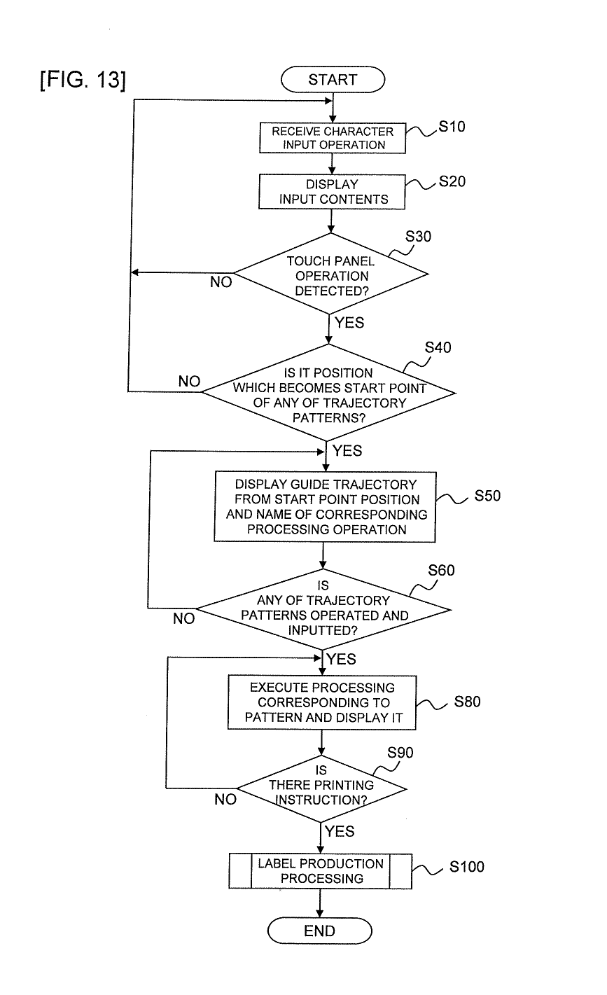

A processing procedure executed by the control circuit 210 in order to realize the above will be described by referring to FIG. 13. This processing is started when a power button 4f of the operation portion 2 of the apparatus 1 is pressed down, for example.

In FIG. 13, at Step S10, first, the control circuit 210 receives the editing operation of the label image M by inputs of characters, symbols and the like and other operations by the operator through the keyboard 3, the function key group 4 or the like. Then, the procedure proceeds to Step S20.

At Step S20, the control circuit 210 outputs a control signal to the liquid crystal panel 5A so as to have the above described label image M in a state according to the edited contents received at the above described Step S10 displayed on the liquid crystal panel 5A. Subsequently, the procedure proceeds to Step S30.

At Step S30, the control circuit 210 determines whether or not the operation of the touch panel portion 5B by the operator has been detected through the touch panel driving circuit 207. That is, detection of contact of the finger 10 on the touch panel portion 5B is made all the time, and its detection signal (a signal indicating whether or not contact is made) is input to the control circuit 210. Then, at this Step S30, the control circuit 210 determines whether or not the detection signal indicating the above described contact has been input. The determination at Step S30 is not satisfied (S30: NO) until the operator touches the finger 10 to the touch panel portion 5B, for example, the procedure returns to the above described Step S10, and the same procedure is repeated. If the operator touches the finger 10 to the touch panel portion 5B, for example, the determination at Step S30 is satisfied (S30: YES), and the procedure proceeds to Step S40. When the determination at this Step S30 is satisfied and after, too, the detection of the finger 10 to the touch panel portion 5B is made, and the detection signal is continuously input into the control circuit 210. Note that, the control circuit 210 executing this Step S30 functions as detecting portion described in each claim.

At Step S40, the control circuit 210 refers to the above described correlation (See FIG. 6) stored in the trajectory pattern memory 220 on the basis of the detection signal from the touch panel portion 5B and determines whether or not the contact position of the finger 10 of the operator on the touch panel portion 5B is a start point position of any of the trajectory patterns (the trajectory patterns K1-K4 in the above described example). If the contact position on the touch panel portion 5B is the start point position of any of the trajectory patterns, the determination is satisfied (Step S40: YES), and the procedure proceeds to Step S50. If the contact position of the touch panel portion 5B is not a start point position of any of the trajectory patterns, the determination is not satisfied (Step S40: NO), the procedure returns to the above described Step S10, and the similar procedure is repeated. Note that, the control circuit 210 executing this Step S40 functions as start point determining portion described in each claim.

At Step S50, the control circuit 210 outputs a control signal to the liquid crystal panel 5A and makes the liquid crystal panel 5A perform guide display of the guide trajectories (the guide trajectories G1-G4, for example) equivalent to the trajectory patterns from the start point position (the contact trajectories K1-K4, for example) and the names of the processing operations corresponding to the guide trajectories. As a result, the operator sees the above described guide trajectories G1-G4 and the names of the processing operations corresponding to them displayed on the liquid crystal panel 5A and selects a desired guide trajectory (any one of the guide trajectories G1-G4. Hereinafter referred to simply as a “guide trajectory G” as appropriate) for performing the desired processing operation. Then, by performing the tracing contact operation of touching the finger 10 on the touch panel portion 5B along the selected desired guide trajectory G, it is possible to operationally input the trajectory pattern for performing the desired processing operation.

That is, for example, by performing the tracing contact operation of touching along the guide trajectory G1 on the touch panel portion 5B, it is possible to operationally input the contact trajectory K1 (See FIG. 7B) associated with the font type changing processing. Similarly, by performing the tracing contact operation of touching along the guide trajectory G2 on the touch panel portion 5B, it is possible to operationally input the contact trajectory K2 (See FIG. 8B) associated with the character size changing processing. Similarly, by performing the tracing contact operation of touching along the guide trajectory G3 on the touch panel portion 5B, it is possible to operationally input the contact trajectory K3 (See FIG. 9B) associated with the frame-line addition processing. Similarly, by performing the tracing contact operation of touching along the guide trajectory G4 on the touch panel portion 5B, it is possible to operationally input the contact trajectory K4 (See FIG. 10B) associated with the italicization processing. When Step S50 is finished as above, the procedure proceeds to Step S60. Note that, the control circuit 210 executing this Step S50 functions as display control portion described in each claim.

At Step S60, the control circuit 210 refers to the above described correlation (See FIG. 6) stored in the trajectory pattern memory 220 on the basis of the detection signal from the touch panel portion 5B and determines whether or not any of the trajectory patterns has been operationally input on the touch panel portion 5B. If any of the trajectory patterns has been operationally input by the operator, the determination is satisfied (Step S60: YES), and the procedure proceeds to Step S80. If no trajectory pattern has been operationally input by the operator, the determination is not satisfied (Step S60: NO), the procedure returns to the above described Step S50, and the same procedure is repeated. Note that, the control circuit 210 executing this Step S60 functions as trajectory determination processing portion described in each claim.

At Step S80, the control circuit 210 outputs a control signal to the above described operation portion executing the processing operation corresponding to the trajectory pattern operationally input at the above described Step S60 and makes the operation portion execute the corresponding processing. Moreover, the control circuit 210 makes the processing result displayed on the liquid crystal panel 5A. As a result, for example, if an operational input of the above described contact trajectory K1 (See FIG. 7B) is made at Step S60, the font type changing processing of the print image R in the label image M displayed on the liquid crystal panel 5A at that point of time is executed (See FIG. 7C). Moreover, if an operational input of the above described contact trajectory K2 (See FIG. 8B) is made at Step S60, the character size changing processing of the print image R in the label image M displayed on the liquid crystal panel 5A at that point of time is executed (See FIG. 8C). Moreover, if an operational input of the above described contact trajectory K3 (See FIG. 9B) is made at Step S60, the frame-line addition processing to the print image R in the label image M displayed on the liquid crystal panel 5A at that point of time is executed (See FIG. 9C). Moreover, if an operational input of the above described contact trajectory K4 (See FIG. 10B) is made at Step S60, the italicization processing of the print image R in the label image M displayed on the liquid crystal panel 5A at that point of time is executed (See FIG. 10C). Subsequently, the procedure proceeds to Step S90. Note that, the control circuit 210 executing this Step S80 functions as operation control portion described in each claim.

At Step S90, the control circuit 210 determines whether or not there is a printing instruction by the operator. That is, the operator gives a printing instruction by pressing the above described print key 4e provided on the operation portion 2. If there is a printing instruction, the determination at Step S90 is satisfied (Step S90: YES), and the procedure proceeds to Step S100. If there is no printing instruction, the determination is not satisfied (Step S90: NO), the procedure returns to the above described Step S80, and the same procedure is repeated.

At Step S100, the control circuit 210 executes production processing (which will be described later) of the print label L on the basis of the label image M displayed at the above described Step S90. Subsequently, this flow is finished.

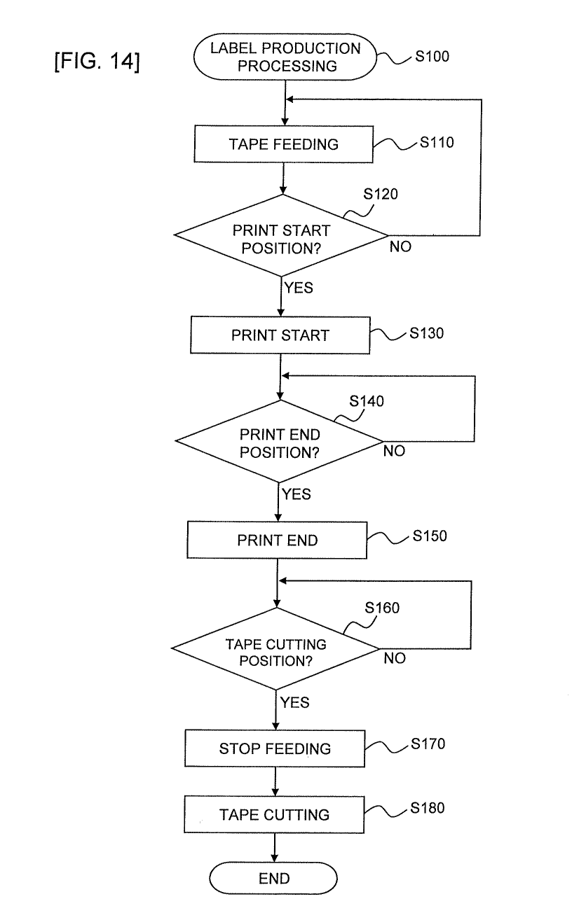

Detailed procedures of the label production processing at the above described Step S100 will be described by using FIG. 14.

In FIG. 14, first at Step S110, the control circuit 210 outputs a control signal to the roller driving circuit 209 so as to start driving of the roller driving motor 209. As a result, the feeding roller driving shaft 108 is rotationally driven and rotation of the feeding roller 27 is started, and as described above, feeding of the cover film 103, the base tape 101, and the label tape 109 with print in which they are bonded together is started. Subsequently, the procedure proceeds to Step S120.

At Step S120, the control circuit 210 determines whether or not the position of the cover film 103 in the feeding direction has arrived at a predetermined print start position by a known method. If the position has not arrived at the print start position yet, the determination is not satisfied (Step S120: NO), the procedure returns to Step S110, and the same procedure is repeated. If the position has arrived at the print start position, the determination at Step S120 is satisfied (Step S120: YES), and the procedure proceeds to Step S130.

At Step S130, the control circuit 210 outputs a control signal (print data) to the print-head driving circuit 205 on the basis of the label image M displayed at the above described Step S80 in FIG. 13. As a result, the heat generating elements 23a of the thermal head 23 are driven in accordance with the print data, and formation of the print corresponding to the print data on the cover film 103 is started. Subsequently, the procedure proceeds to Step S140.

At Step S140, the control circuit 210 determines whether or not the position of the cover film 103 in the feeding direction has arrived at a predetermined print end position by a known method. If the position has not arrived at the print end position yet, the determination is not satisfied (Step S140: NO), and the procedure waits in a loop. When the position has arrived at the print end position, the determination at Step S140 is satisfied (Step S140: YES), and the procedure proceeds to Step S150.

At Step S150, the control circuit 210 outputs a control signal to the print-head driving circuit 205, stops energization to the heat generating elements 23a of the thermal head 23 corresponding to the above described print data, and finishes the printing. Subsequently, the procedure proceeds to Step S160.

At Step S160, the control circuit 210 determines whether or not a position of the label tape 109 with print in the feeding direction has arrived at a tape cutting position by a known method. The determination is not satisfied (Step S160: NO) until the position arrives at the tape cutting position, and the procedure waits in a loop. If the position arrives at the tape cutting position, the determination at Step S160 is satisfied (Step S160: YES), and the procedure proceeds to Step S170.

At Step S170, the control circuit 210 outputs a control signal to the roller driving circuit 209 and stops driving of the roller driving motor 208. As a result, rotation of the feeding roller 27 is stopped, and feeding of the cover film 103, the base tape 101, and the label tape 109 with print in which they are bonded together is stopped. Subsequently, the procedure proceeds to Step S180.

At Step S180, the control circuit 210 outputs a control signal to the cutter-solenoid driving circuit 300. As a result, the cutter solenoid 280 is energized and excited, and the cutter 40 performs the cutting operation and cuts the label tape 109 with print to a predetermined length. As a result, the print label L having print contents based on the label image M edited by the operator (See FIG. 2) is created. Subsequently, this flow is finished.

It is to be noted that the present disclosure is not limited to the above described embodiment but is capable of various variations within a range not departing from the gist and technical idea thereof. Such variations will be described below in order.

(1) If mode of guide display is changed by arrival position of fingertip:

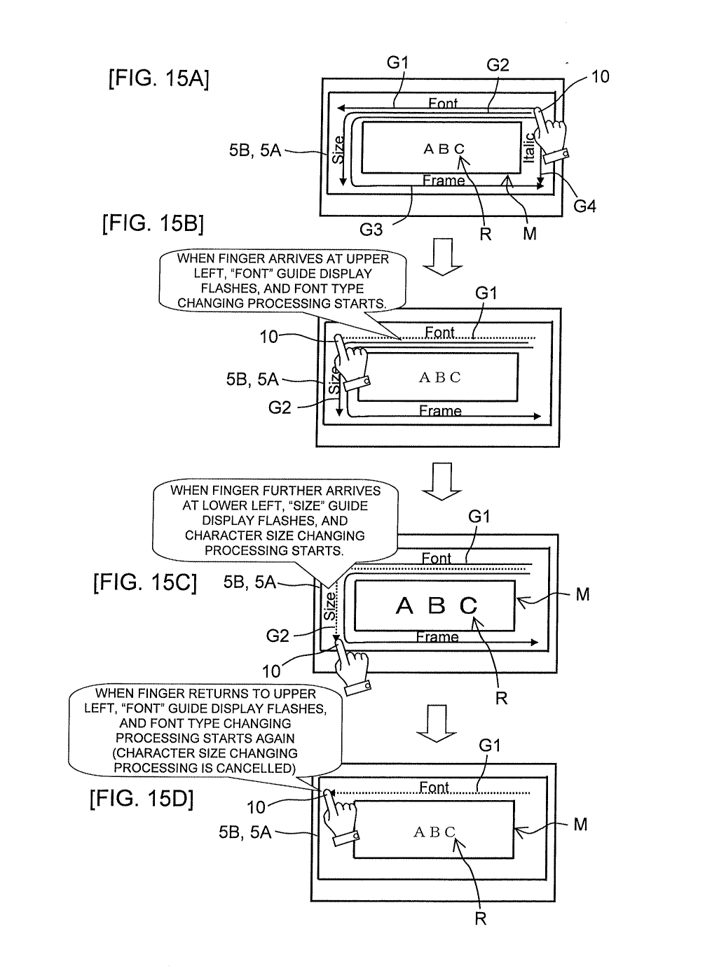

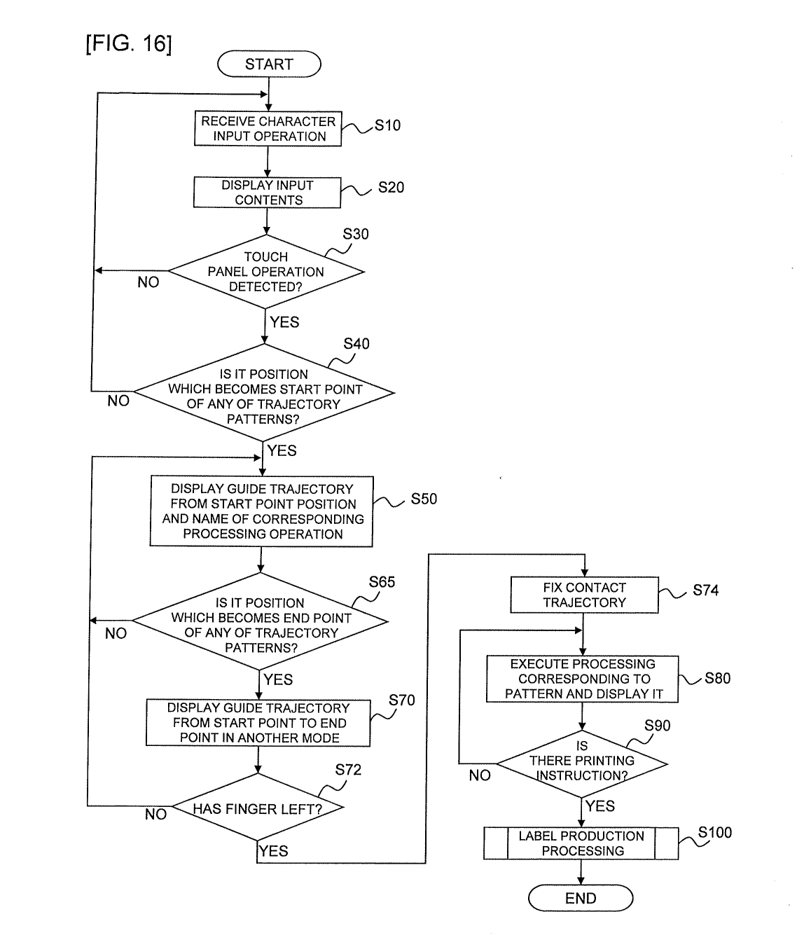

That is, in the guide trajectory G displayed on the liquid crystal panel 5A, a part where an operational input along that has been already made may be displayed in a mode different from that of the other parts. Such the variation will be described by referring to FIGS. 15 and 16.

<Display of Liquid Crystal Panel>

For example, FIG. 15A displays, in a view, the guide trajectories G1-G4 equivalent to all the trajectory patterns K1-K4 starting at the upper right part of the liquid crystal panel 5A by contact on the upper part on the right side of the touch panel portion 5B and the names of the processing operations corresponding to the guide trajectories G1-G4 similarly to FIG. 11B.

From the above described state, if the operator traces along the guide trajectory G1 (in the forward direction) leftward with the finger 10 as illustrated in FIG. 15B, for example, the finger 10 moves to the upper left part (that is, the end point of the guide trajectory G1) of the touch panel portion 5B. Then, display of the guide trajectory G1 on the liquid crystal panel 5A changes to display in another mode different from the guide trajectories G2-G3 other than the guide trajectory G1 (in this example, flashing display (schematically indicated by a dotted line in FIG. 15B. The same applies to the following). As a result, it is recognized that the contact trajectory K1 corresponding to the guide trajectory G1 has been operationally input, thus the font type changing processing is executed, and in the label image M displayed on the liquid crystal panel 5A, the font type of the characters “ABC” of the print image R is changed from Gothic to Ming style, for example. If the finger 10 leaves the touch panel portion 5B at this timing, an operational input of the contact trajectory K1 is fixed (execution of the font type changing processing is fixed) (See Step S74 in FIG. 16 which will be described later).

Subsequently, from the state in the above described FIG. 15B, if the operator further traces the touch panel portion 5B downward which is the same (forward) direction as the guide direction of the second half part of the guide trajectory G2 as illustrated in FIG. 15C, for example, the finger 10 moves to the lower left part of the touch panel portion 5B (that is, the end point of the guide trajectory G2). Then, the display of the guide trajectory G1 returns to the original mode from flashing and the guide trajectory G2 changes to the flashing display instead. As a result, it is recognized that the contact trajectory K2 corresponding to the guide trajectory G2 has been operationally input, thus the character size changing processing is executed, and in the label image M displayed on the liquid crystal panel 5A, the character size of the characters “ABC” of the print image R is changed from the character size 18 to the character size 28, for example. If the finger 10 leaves the touch panel portion 5B at this timing, an operational input of the contact trajectory K2 is fixed (execution of the character size changing processing is fixed) (See Step S74 in FIG. 16 which will be described later).

Subsequently, from the state in the above described FIG. 15C, the operator traces the guide trajectory G2 upward in a direction opposite to the guide direction of the guide trajectory G2 with the finger 10 having moved to the lower left part of the touch panel portion 5B and returns the finger 10 to the upper left part of the touch panel portion 5B as illustrated in FIG. 15D, for example. Then, in the liquid crystal panel 5A, the display of the guide trajectory G2 is lost (in this example, the guide trajectory G3 is also lost), and the display of the above described guide trajectory G1 flashes again. As a result, the operational input of the contact trajectory K2 up to the state in FIG. 15C is cancelled, the corresponding character size changing processing is cancelled, the state changes to an operational input state of the contact trajectory K1, and the corresponding font type changing processing is executed. As a result, in the label image M displayed on the liquid crystal panel 5A, the characters “ABC” of the print image R return to the same state as FIG. 15B, and the characters “ABC” are displayed in the Ming style font with the character size 18. If the finger 10 leaves the touch panel portion 5B at this timing, an operational input of the contact trajectory K2 is fixed (execution of the font type changing processing is fixed) (See Step S74 in FIG. 16 which will be described later).

<Control Procedure>

In order to realize the above, a processing procedure executed by the control circuit 210 of this variation will be described by referring to FIG. 16. In a flowchart in FIG. 16, Step S60 in the flowchart in FIG. 13 is deleted, and Step S65, Step S70, Step S72, and Step S74 are newly provided between Step S50 and Step S80.

In FIG. 16, Step S10 to Step S50 are similar to FIG. 13. At the above described Step S50, as described above, the guide trajectories G1-G4 from the start point position and the names of the processing operations corresponding to those guide trajectories G1-G4 are guide-displayed on the liquid crystal panel 5A and then, the procedure proceeds to the newly provided Step S65.

At Step S65, the control circuit 210 refers to the above described correlation (See FIG. 6) stored in the trajectory pattern memory 220 on the basis of the detection signal from the touch panel portion 5B and determines whether or not the contact position of the finger 10 of the operator in the touch panel portion 5B is at a position which becomes an end point of any of the trajectory patterns K1-K4. If the contact position in the touch panel portion 5B is at the end point position of any of the trajectory patterns K, the determination is satisfied (Step S65: YES), and the procedure proceeds to the newly provided Step S70. If the contact position in the touch panel portion 5B is not an end point position of any of the trajectory patterns K, the determination is not satisfied (Step S65: NO), the procedure returns to the above described Step S50, and the same procedure is repeated.

At Step S70, the control circuit 210 outputs a control signal to the liquid crystal panel 5A and displays the guide trajectory G corresponding to the trajectory pattern K determined to be a start point position at the above described Step S40 and determined to be an end point position at Step S65 in another mode different from the other guide trajectories G (in this example, flashing display). Subsequently, the procedure proceeds to the newly provided Step S72. The control circuit 210 executing the above described Step S70 and the previously described Step S50 functions as display control portion described in each claim.

At Step S72, the control circuit 210 determines whether or not the finger 10 has left the touch panel portion 5B on the basis of the detection signal from the touch panel portion 5B. If the finger 10 is touching the touch panel portion 5B, the determination is not satisfied (Step S72: NO), the procedure returns to Step S50, and the same procedure is repeated. If the finger 10 has left the touch panel portion 5B, the determination is satisfied (Step S72: YES), and the procedure proceeds to the newly provided Step S74. Note that, the control circuit 210 executing Step S72 functions as end point determining portion described in each claim.

At Step S74, the control circuit 210 fixes the trajectory pattern K determined to be a start point position at Step S40 and determined to be an end point position at Step S65 (in other words, the trajectory pattern K corresponding to the guide trajectory G displayed in another mode at Step S70) as the trajectory pattern operationally input by the operator this time. Subsequently, the procedure proceeds to Step S80. Note that, the control circuit 210 executing Step S74 functions as trajectory fixing portion described in each claim. Then, the control circuit 210 executing this Step S74 and Step S72 functions as trajectory determination processing portion described in each claim.

After the above, Step S80 to Step S100 are similar to FIG. 13, and the description will be omitted.

(2) If cancellation is made possible by operation deviating out of predetermined range:

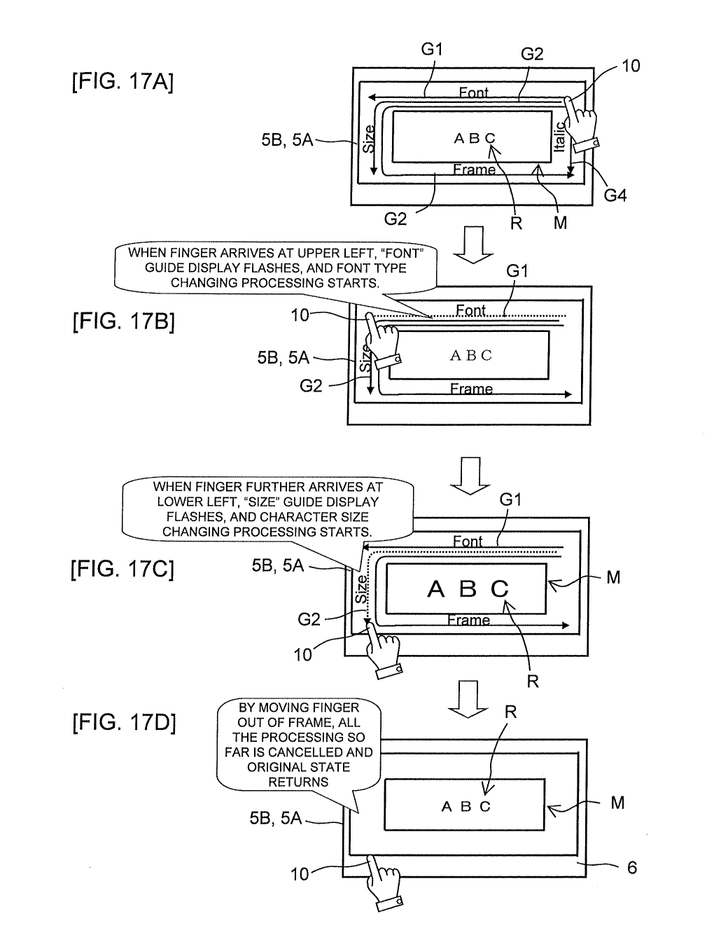

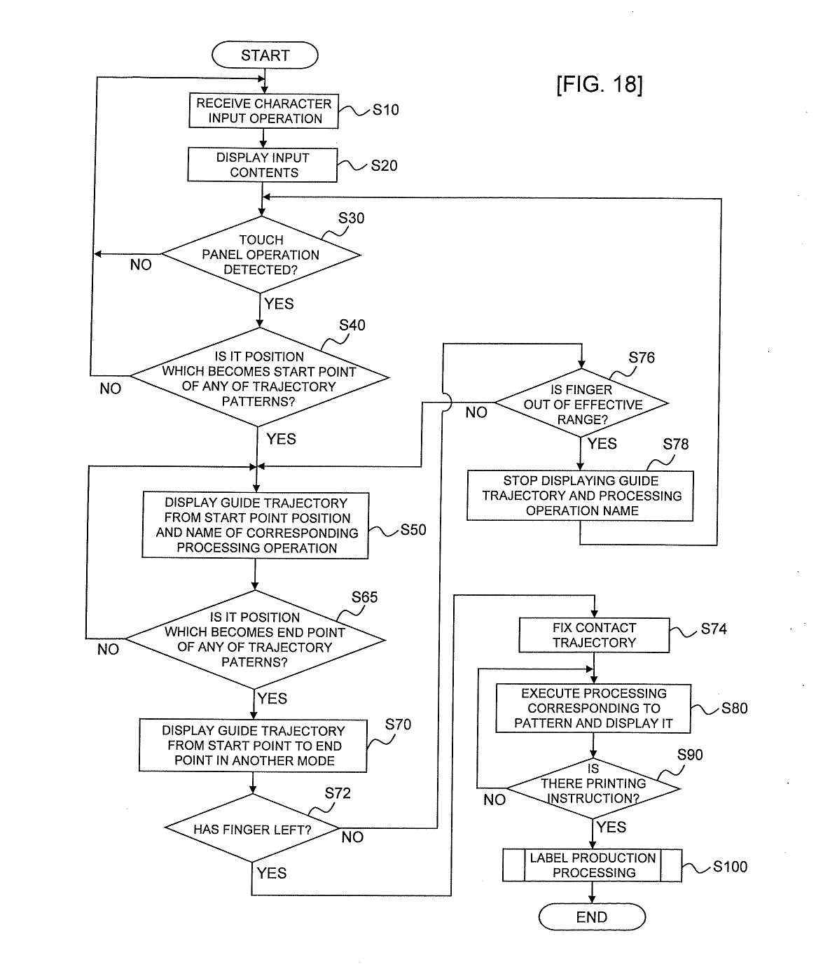

In this variation, if a trajectory deviating to the outside of a contact trajectory effective range (contact trajectory out of range) set in advance in the touch panel portion 5B is operationally input, the guide display of the processing operation having been executed so far is stopped. This variation will be described by referring to FIGS. 17 and 18.

<Display of Liquid Crystal Panel>

Assume a case in which the operations illustrated in the above described FIGS. 15A to 15C and FIGS. 17A to 17C which are similar, respectively, are performed, for example. As described above, if the finger 10 moves from the state in which contact to the upper right part of the touch panel portion 5B is made (FIG. 17A) to the upper left part of the touch panel portion 5B (FIG. 17B) as described above, the guide trajectory G1 flashes in display, and the font type changing processing is executed. If the finger 10 further moves to the lower left part of the touch panel portion 5B (FIG. 17C), the guide trajectory G2 flashes in display, and the character size changing processing is executed.

Subsequently, the finger 10 further moves downward on the touch panel portion 5B from the state in FIG. 17C and arrives at a region out of a contact trajectory effective range (it may be a whole region inside the outer edge of the touch panel portion 5B or may be a region separately set inside the outer edge so as to become somewhat smaller than the above described whole region) of the touch panel portion 5B as illustrated in FIG. 17D, for example. Then, all the processing operations having been executed so far (the font type changing processing and the character size changing processing in this example) are cancelled and at the same time, all the guide displays so far (the guide trajectories G1, G2, G3, and G4 in FIGS. 17A to 17C) are stopped, and the state returns to a state where no guide display is made.

<Control Procedure>

In order to realize the above, the processing procedure executed by the control circuit 210 of this variation will be described by referring to FIG. 18. In a flowchart in FIG. 18, Step S76 and Step S78 are newly provided between Step S50 and Step S72 in the flowchart in FIG. 16.

In FIG. 18, Step S10 to Step S72 are similar to FIG. 16. At the above described Step S72, if the finger 10 is touching the touch panel portion 5B, the determination is not satisfied (Step S72: NO), and the procedure proceeds to the newly provided Step S76.

At Step S76, the control circuit 210 determines whether or not the finger 10 has deviated out of the contact trajectory effective range of the touch panel portion 5B on the basis of the detection signal from the touch panel portion 5B. If the finger 10 is located within the contact trajectory effective range, the determination is not satisfied (Step S76: NO), the procedure returns to Step S50, and the same procedure is repeated. If the finger 10 has deviated out of the contact trajectory effective range, the determination is satisfied (Step S76: YES), and the procedure proceeds to Step S78. Note that, the control circuit 210 executing Step S76 functions as out-of-range determining portion described in each claim. Moreover, the control circuit 210 executing this Step S76, Step S72, and Step S74 functions as trajectory determination processing portion described in each claim.

At Step S78, the control circuit 210 outputs a control signal to the liquid crystal panel 5A and stops display of the guide trajectory G and the name of the processing operation corresponding to the guide trajectory G having been displayed. The control circuit 210 executing this Step S78, Step S30, Step S50, and Step S70 functions as display control portion described in each claim. When Step S78 is finished, the procedure returns to Step S30, and the same procedure is repeated.

Each procedure other than the above is the same as in FIG. 16, and description will be omitted.

In this variation, if the operation on the touch panel portion 5B deviates out of the contact trajectory effective range set in advance, processing having been executed so far is invalidated, and the display of the guide trajectory G having been executed so far is stopped. As a result, after the operator began to draw the contact trajectory at one point (start point) on the touch panel portion 5B, by having the trajectory deviate out of the contact trajectory effective range, it is possible to substantially cancel all the operational inputs so far. As a result, convenience can be further improved.

(3) If all the guide trajectories are displayed by specific operation:

That is, in this variation, as illustrated in FIG. 19A, for example, a contact operation in a specific mode (double click in this example) is performed for an arbitrary point on the touch panel portion 5B. Then, as illustrated in FIG. 19B, on the liquid crystal panel 5A, the guide trajectories G1-G7 equivalent to all the contact trajectories K1-K7 that can be operationally input on the touch panel portion 5B and the names of the processing operations corresponding to each of the guide trajectories G1-G7 are displayed in a view.

In the illustrated example, display of the guide trajectory G1 and “Font”, the guide trajectory G2 and “Size”, the guide trajectory G3 and “Frame”, and the guide trajectory G4 and “Italic” similar to the above are displayed as guide display. Moreover, in addition to the above, display of a guide trajectory G5 with a rightward straight line pattern and a name “Print” indicating printing processing corresponding to the guide trajectory G5 (by collaboration of the feeding roller driving shaft 108 and the thermal head 23), display of a guide trajectory G6 with an upward pattern and a name “Cut” indicating cutting processing (by the cutter 40) corresponding to the guide trajectory G6, and display of a guide trajectory G7 with a rightward and then, upward L-shaped pattern and a name “Print & Cut” indicating printing/cutting processing corresponding to the guide trajectory G7 are performed.

(4) If used in a mobile operation terminal such as smart phone:

That is, in this variation, a mobile operation terminal (such as a so-called smart phone) is used which is connected capable of transmitting/receiving information to a print label producing apparatus as an electronic device and includes a touch panel portion and a display portion such as a liquid crystal panel. An operation display method of the operation terminal is executed by all the procedures up to Step S90 in each of FIGS. 13, 16, and 18 by appropriate calculating portion provided in the mobile operation terminal. If a printing instruction by appropriate operating portion of the mobile operation terminal is given and the determination at Step S90 is satisfied, at Step S100′ (not shown) newly provided in accordance with Step S100, print data created so far (corresponding to the label image M created through all the procedures up to Step S90) is transmitted from the mobile operation terminal to the print label producing apparatus and the printing instruction is performed. As a result, the print label L corresponding to the print data can be produced by the apparatus 1 which received the print data.

In this case, the correlation is stored in an appropriate memory (corresponding to memory) provided in the mobile operation terminal Moreover, Step S30 corresponds to a detection procedure described in each claim, Step S60 in FIG. 13, Step S72 and Step S74 in FIG. 16, and Step S76, Step S72 and Step S74 in FIG. 18 correspond to a trajectory determination processing procedure. Moreover, Step S80 in FIGS. 13, 16, and 18 corresponds to an operation control procedure, and Step S40 corresponds to a start point determination procedure. Moreover, Step S50 in FIG. 13, Step S50 and Step S70 in FIG. 15, Step S30, Step S50, Step S70, and Step S78 in FIG. 18 correspond to a display control procedure.

In the above, the arrows illustrated in FIG. 5 indicate examples of flows of signals and do not limit the flow directions of the signals.

Moreover, the flowcharts illustrated in FIGS. 13, 14, 16, and 18 are not intended to limit the present disclosure to the procedures illustrated in the above described flows but addition/deletion or change of order and the like of the procedures may be made within a range not departing from the gist and technical idea of the present disclosure.

Moreover, other than those described above, methods of the above described embodiment and the variations may be used in combination as appropriate.

Other than the above, though not individually exemplified, the present disclosure is put into practice with various changes added within a range not departing from the gist thereof.

What is claimed is:

1. An electronic device comprising:
at least one operation portion which is configured to be capable of executing a predetermined processing operation and includes a display portion configured to perform a desired display;
a touch panel portion provided above said display portion and capable of executing an operational input in a state where display on the display portion can be seen through;
a detecting portion configured to detect the operational input by contact to said touch panel portion;
a memory configured to store correlation between contact trajectories with a plurality of predetermined patterns in said touch panel portion and a plurality of said processing operations corresponding to the plurality of predetermined patterns, respectively;
a trajectory determination processing portion configured to determine whether or not a contact trajectory with any of said predetermined patterns has been operationally input in said touch panel portion on the basis of a detection result of said detecting portion;
an operation control portion configured, when it is determined by said trajectory determination processing portion that a contact trajectory with said predetermined pattern has been operationally input, to refer to said correlation stored in said memory and control said operation portion corresponding to the contact trajectory with the predetermined pattern so as to perform said processing operation corresponding to the predetermined pattern;
a start point determining portion configured to determine whether or not contact that can become a start point of the contact trajectory with at least one of said predetermined pattern has been made in said touch panel portion, on the basis of the detection result of said detecting portion; and
a display control portion configured, when it is determined by said start point determining portion that contact that can become said start point has been made, to refer to said correlation stored in said memory and control said display portion so as to perform guide display of at least one of said processing operations corresponding to the contact trajectory with at least one of said predetermined pattern including the start point, respectively.

2. The electronic device according to claim 1, wherein:
said start point determining portion determines whether or not contact that can become a start point of the contact trajectory with said predetermined pattern has been made in accordance with which portion in said touch panel portion the contact point detected by said detecting portion corresponds to.

3. The electronic device according to claim 1, wherein:
said display control portion controls said display portion so as to perform guide trajectory display equivalent to contact trajectory with at least one of said predetermined pattern including said start point as said guide display, respectively.

4. The electronic device according to claim 3, wherein:
said display control portion controls said display portion so as to further display a name of said at least one processing operation corresponding to said at least one said predetermined pattern as said guide display, respectively.

5. The electronic device according to claim 3, wherein:
said trajectory determination processing portion determines whether or not a contact trajectory with said predetermined pattern along any one of the plurality of said guide trajectory displays displayed by the control of said display control portion on said display portion has been operationally input on the basis of the detection result of said detecting portion; and
said display control portion, when it is determined by said trajectory determination processing portion that the contact trajectory with said predetermined pattern along said one guide trajectory display has been operationally input, controls said display portion so as to display a part of said one guide trajectory display corresponding to said operationally input contact trajectory among said plurality of guide trajectory displays in a mode different from the other parts than the part of said one guide trajectory display.

6. The electronic device according to claim 3, wherein:
said trajectory determination processing portion has:
an end point determining portion configured to determine whether or not separation from said touch panel portion that can become an end point of contact trajectory with at least one of said predetermined pattern has been made on the basis of the detection result of said detecting portion; and
a trajectory fixing portion configured to fix the contact trajectory from said start point determined by said start point determining portion to said end point determined by said end point determining portion as an operationally input contact trajectory when it is determined by said end point determining portion that the separation from said touch panel portion has been made, and
said operation control portion refers to said correlation stored in said memory for the contact trajectory fixed by said trajectory fixing portion and control said operation portion corresponding to the contact trajectory with said predetermined pattern equivalent to the fixed contact trajectory so as to perform said processing operation corresponding to the predetermined pattern.

7. The electronic device according to claim 6, wherein:
said trajectory determination processing portion determines whether or not, after a forward contact trajectory in the same direction as a guide direction along a part of said guide trajectory display, a backward contact trajectory in a direction opposite to said guide direction has been operationally input along the forward contact trajectory in said touch panel portion on the basis of the detection result of said detecting portion; and
said trajectory fixing portion fixes the contact trajectory from said start point to said end point as an operationally input contact trajectory by excluding said forward contact trajectory and said backward contact trajectory when it is determined by said trajectory determination processing portion that said backward contact trajectory has been operationally input.

8. The electronic device according to claim 3, wherein:
said trajectory determination processing portion has an out-of-range determining portion configured to determine whether or not an out-of-range contact trajectory deviating out of a contact trajectory effective range set in advance has been operationally input in said touch panel portion on the basis of the detection result of said detecting portion;
said start point determining portion invalidates a determination result regarding said start point having been executed so far when it is determined by said trajectory determination processing portion that said out-of-range contact trajectory has been operationally input; and
said display control portion controls said display portion so as to stop the guide display of said processing operation having been executed so far.

9. The electronic device according to claim 3, further comprising a contact mode determining portion configured to determine whether or not a contact in a predetermined mode for displaying all the patterns has been made in said touch panel portion on the basis of the detection result of said detecting portion, wherein
said display control portion controls said display portion so as to perform said guide trajectory display equivalent to the contact trajectories with all of said predetermined patterns stored in said memory, respectively, when it is determined by said contact mode determining portion that the contact in the predetermined mode for displaying all the patterns has been made.

10. An operation display method for an operation terminal which is configured to be capable of being connected to an electronic device including at least one operation portion executing a predetermined processing operation, the operation terminal having a display portion configured to perform a desired display, a touch panel portion provided above said display portion and capable of executing an operational input in a state where display on the display portion can be seen through, and a memory configured to store correlation between contact trajectories with a plurality of predetermined patterns in said touch panel portion and a plurality of said processing operations executed by said operation portion or said display portion in accordance with the plurality of predetermined patterns, respectively, the operation display method comprising the steps of:
a detection step for detecting the operational input by contact to said touch panel portion;
a trajectory determination processing step for determining whether or not a contact trajectory with any of said predetermined patterns has been operationally input in said touch panel portion on the basis of a detection result in said detection step;
an operation control step, when it is determined in said trajectory determination processing step that the a contact trajectory with said predetermined pattern has been operationally input, for referring to said correlation stored in said memory and for controlling said operation portion or said display portion in accordance with the contact trajectory with the predetermined pattern so as to perform said processing operation corresponding to the predetermined pattern;
a start point determining step for determining whether or not contact that can become a start point of the contact trajectory with at least one of said predetermined pattern has been made in said touch panel portion on the basis of the detection result in said detection step; and
a display control step, when it is determined in said start point determination step that contact that can become said start point has been made, for referring to said correlation stored in said memory and for controlling said display portion so as to perform guide display of at least one of said processing operations corresponding to the contact trajectory with at least one of said predetermined pattern including the start point, respectively.
